(19) United States
(12) Patent Application Publication
(10) Pub. No.: US 2025/0309718 A1
(43) Pub. Date: Oct. 2, 2025

(54) POWER-GENERATING COMPONENT OF AN ELECTRIC MACHINE

(71) Applicant: ZF FRIEDRICHSHAFEN AG, Friedrichshafen (DE)

(72) Inventors: Kai MEHLSTÄUBL, Neidlingen (DE); Robin MICHELBERGER, Schweinfurt (DE); Matthias EBERT, Himmelstadt (DE)

(21) Appl. No.: 18/866,323

(22) PCT Filed: May 11, 2023
(86) PCT No.: PCT/EP2023/062632

§ 371 Date: Nov. 15, 2024

(30) Foreign Application Priority Data
May 17, 2022 (DE) 10 2022 204 818.0

(51) Int. Cl. H02K 3/28; H02K 3/14

(52) U.S. Cl. CPC H02K 3/28; H02K 3/14

(57) ABSTRACT

A power-generating component of an electric machine having an annular lamination stack with a plurality of radially arranged slots and a wave winding with at least a first and a second continuous conductor guided in in a plurality of revolutions through adjacent slots and which are connected in parallel or in series and form a composite conductor. The composite conductor has a slot jump in which the first conductor and the second conductor span an equal number of slots and in which there is a layer change. The composite conductor has at least one slot jump change in which the first conductor and the second conductor span different numbers of slots such that the arrangement of the first conductor and the second conductor relative to one another is swapped after the slot jump change. There is at least one slot jump change within every revolution of the composite conductor.

### CROSS REFERENCE TO RELATED APPLICATIONS

This is a U.S. national stage of Application No. PCT/EP2023/062632 filed May 11, 2023. Priority is claimed on German Application No. DE 10 2022 204 818.0 filed May 17, 2022 the content of which is incorporated herein by reference.

### BACKGROUND OF THE INVENTION

### 1. Field of the Invention

The disclosure is directed to a power-generating component of an electric machine, such as a rotor or a stator of an electric motor. The power-generating component comprises an annular lamination stack with a plurality of radially arranged slots and a wave winding with at least a first continuous conductor and a second continuous conductor which are guided in each instance in a plurality of revolutions through adjacent slots and which are connected in parallel or in series and form a composite conductor. The composite conductor has a slot jump in which the first conductor and the second conductor, respectively, span an equal number of slots and in which there is a layer change. Further, the composite conductor has at least one slot jump change in which the first conductor and the second conductor span different numbers of slots such that the arrangement of the first conductor and the second conductor relative to one another is swapped after the slot jump change.

### 2. Description of the Related Art

Electric motors for vehicles comprise a stator and a rotor as power-generating components. Both of these component parts are assembled from laminations that are insulated from one another and stacked one upon the other and which form a lamination stack and are configured in each instance as an annulus having circumferential slots. Conductors, generally copper wires or conductor bundles, are wound around the slots to form windings of a coil.

Wave winding is one possibility for winding these lamination stacks. To this end, winding mats are usually provided, which are inserted into the slots and subsequently contacted. Alternatively, a direct winding around a lamination stack is also possible. In this regard, it is important that all of the elements of the electric motor be insulated from one another, for example, by films or paper. Lastly, the slots are sealed with slot liners and potted with a casting medium for better durability and insulation.

In wave winding, a conductor is guided through a slot, spans a fixed number of slots and is guided through a further slot. The area of the conductor spanning the plurality of slots is referred to as a winding head. The power-generating component of the electric machine or electric motor is wrapped in its entirety in this way with a plurality of conductors in a plurality of layers. The layer of the conductor is the radial position of the conductor within the respective slot. To maximize efficiency, smooth running and robustness, it is necessary to selectively adapt the path of the individual conductors to one another. In this regard, it is also necessary, inter alia, that the individual conductors change with respect to layer in a slot jump.

DE 10 2014 223 202 A1 discloses a wave winding for a stator in which the wave winding has at least two conductors for one respective phase of the machine, which are interconnected in parallel and/or in series and are arrangeable at a given winding pitch in a number of at least two successive stator slots of each magnetic pole and each phase of the machine in a sequence predefined for each phase and for one respective magnetic pole along the circumference of the machine. The predefined sequence of interconnected conductors is swapped in at least one position along the circumference of the machine by at least one slot jump change which is defined in DE 10 2014 223 202 A1 as a groove skip. The winding heads of the conductor are formed in a curved manner and rotated once around their axis. The problem here is that the conductors, which have a rectangular cross section, bulk up at this location as a result of this rotation. Thus, particularly during slot jump changes, the conductors are no longer neatly guided, which reduces the efficiency and smooth running of the electric motor.

### SUMMARY OF THE INVENTION

It is an object of one aspect of the invention to provide a power-generating component for an electric motor with a comparatively improved efficiency and smoother running.

According to one aspect of the invention the power-generating component of an electric machine described in the introductory part has at least one slot jump change within every revolution of the composite conductor. This higher number of slot jump changes compared with the prior art enables a smoother running and an improved efficiency, since a high electromagnetic symmetry is achieved in this way.

In an advantageous configuration, the slot jump is formed in a curved manner and has an S-shaped twist at its apex. Conductors with a rectangular cross-section are most often used to achieve the highest possible packing density within the individual slots. This prevents the twisting of the conductor which was known heretofore from the prior art and which leads to a higher space requirement and impedes a denser arrangement in the area of the slot jumps.

Further, it is advantageous when the slot jumps of the first conductor and second conductor are arranged parallel to one another. This also enables an especially tight arrangement of the conductors in the area of the slot jumps.

In a further advantageous configuration, the slot jump changes are arranged radially adjacent to one another at the lamination stack. This makes it possible to arrange the conductors as close together as possible also in the area of the slot jump changes. In this respect, it is particularly advantageous when, in a first slot jump change, the first conductor spans one slot less compared with the slot jump and the second conductor spans one slot more compared with the slot jump and, in a second slot jump change, the first conductor spans one slot more compared with the slot jump and the second conductor spans one slot less compared with the slot jump, wherein the second slot jump change takes place exactly one revolution before or after the first slot jump change.

It is also particularly advantageous when the first conductor spans two slots more compared with the slot jump and the second conductor spans the same number of slots compared with the slot jump, or the first conductor spans the same number of slots compared with the slot jump and the second conductor spans two slots less compared with the slot jump. Accordingly, together with a variation in the number of slots which spans a slot jump, a displacement of a winding layer of the first conductor (fractional pitch or chording) is achieved and the electric motor is acoustically optimized. In this respect, it is particularly advantageous when the third slot jump change takes place on the first and/or second slot jump change. This winding pattern has turned out to be particularly favorable with respect to smooth running, acoustic optimization and efficiency.

It is further advantageous when the wave winding has a plurality of phases comprising one or more composite conductors in each instance. This improves the efficiency of the electric motor in that the phases can be connected one after the other. Any slot jump changes in the individual phases are ideally arranged adjacently because this is advantageous for the smooth running and efficiency of the electric motor.

The above-stated object is also met through a wave winding, already described, for insertion in a power-generating component of an electric machine. This can be directly inserted into the rotor or stator in the form of a winding mat.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following by embodiment examples with reference to the accompanying drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to avoid repetition. The drawings show:

FIG. 1 is a stator with a conductor; and

FIG. 2 is a schematic diagram of a winding scheme.

### DETAILED DESCRIPTION OF THE PRESENTLY PREFERRED EMBODIMENTS

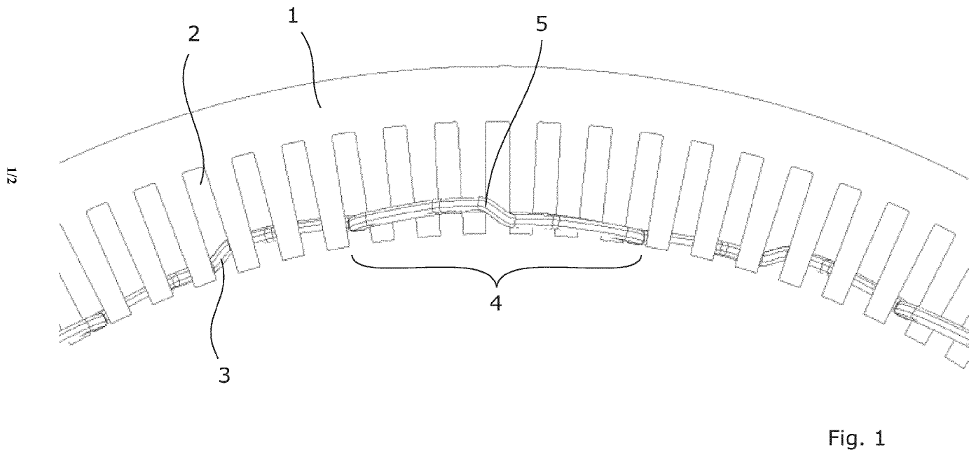

FIG. 1 shows a lamination stack 1 of a stator as power-generating component with a plurality of slots 2 through which a conductor 3 runs. This conductor 3 is guided through a first slot 2, passes into a winding head 4 which spans a first number of slots 2 and is guided through a second slot 2 on the opposite side of the lamination stack 1, where there is a further winding head 4. In this way, the conductor 3 is guided in a plurality of revolutions around the stator. The winding head 4 is curved and, in this embodiment, spans exactly six slots 2. It has an S-shaped twist 5 at its apex so that adjacent conductors 3, not shown, can be arranged close beside conductor 3. In particular, the conductor 3, which has a rectangular cross section, is not rotated once around its own axis in the area of the winding head 4. Further, there is a layer change at the winding head 4, which corresponds to a change of the radial position of the conductor 3 within the slots 2. This is brought about by the S-shaped twist 5.

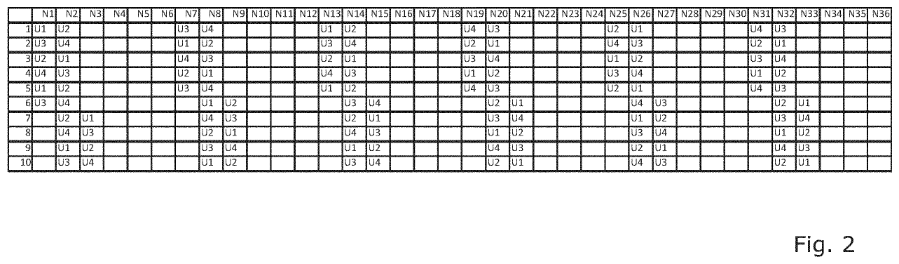

FIG. 2 shows a schematic diagram of a winding scheme for a wave winding of the lamination stack 1 which has exactly thirty-six slots N1, . . . , N36. The first row indicates the numbering for the exact designation of the slots N1, . . . , N36. The first column indicates a layer L1, . . . , L10 within a slot N1, . . . , N36. Layer L1 is a position at a base of the respective slot N1, . . . , N36, and the distance from the base increases as the reference number increases. Accordingly, the path of each conductor 3 through the slots N1, . . . , N36 of the lamination stack 1 can be exactly tracked, and it has a winding head 4 spanning a number of slots N1, . . . , N36 always alternating from a first side to a second side of the lamination stack 1.

All of the conductors 3 for a phase are entered in the winding scheme, and the winding of a first conductor U1, second conductor U2, third conductor U3 and fourth conductor U4 is described. The first conductor U1 and the second conductor U2 form a first composite conductor, and the third conductor U3 and the fourth conductor U4 form a second composite conductor, all of the conductors U1, U2, U3, U4 being connected in series or in parallel and accordingly form a common phase. For ease of comprehension, the slots N1, . . . , N36 spanned by the four conductors U1, U2, U3, U4 have not been entered. Conductors 3 which are associated with one or more phases individually or in one or more composite conductors are also guided into these slots N1, . . . , N36. Their arrangement can correspond to, or also deviate from, that of the first and second composite conductors.

The first conductor U1 and the second conductor U2 start on the first side of the lamination stack 1 and are guided through the first two, adjacent slots N1 and N2, respectively. They exit on a second side of the lamination stack 1 and span the six slots N2 to N7 in a slot jump in which the winding heads 4 of the first conductor U1 and second conductor U2 run in parallel, so that they are guided through the adjacent slots N7 and N8, respectively, to the first side of lamination stack 1. During the slot jump, a layer change from layer L1 to layer L2 is also carried out. On the first side, a further slot jump is then carried out with a further layer change. This is continued until all thirty-six slots N1, . . . , N36 have been passed through or spanned in this manner so that a revolution is carried out and the pattern starting in the first two slots N1 and N2 is continued into the next layers, in this case, L3 and L4. Accordingly, the power-generating component has five revolutions in ten layers L1, . . . , L10. However, this quantity is generally freely selectable and depends on the size of the component so that there is a large number of revolutions.

A first slot jump change in which the first conductor U1 and the second conductor U2 span a different number of slots N1, . . . , N36 is carried out between the thirteenth slot N13 and the twenty-first slot N21 in the first revolution. The first conductor U1 spans one slot N1, . . . , N36 more, i.e., seven, compared with the slot jump, and the second conductor U2 spans one slot N1, . . . , N36 less, i.e., five, compared with the slot jump, so that its position within the composite conductor is swapped. Exactly one revolution later, a second slot jump change takes place in which the first conductor U1 spans one slot N1, . . . , N36 less compared with the slot jump and the second conductor U2 spans one slot N1, . . . , N36 more compared with the slot jump. Accordingly, the first conductor U1 and second conductor U2 swap positions in the composite conductor and are again located in their initial position.

In a third revolution, the first conductor U1 and the second conductor U2 are offset relative to one another in that the first slot jump of the third revolution spans seven slots N1, . . . , N36 and the second slot jump of this revolution spans five slots N1, . . . , N36. A third slot jump change is then carried out in which the first conductor U1 spans eight slots N1, . . . , N36 and the second conductor U2 normally spans six slots N1, . . . , N36. A further second slot jump and then a first slot jump are carried out. This causes a winding layer in which the composite conductor is located to be shifted toward the right by one slot N1, . . . , N36. This so-called chording optimizes the acoustic properties of the electric motor provided with such a power-generating component. The fourth revolution and fifth revolution are carried out in each instance with slot jumps which span six slots N1, . . . , N36, a second slot jump change being carried out in the fourth revolution and a first slot jump change taking place in the fifth revolution.

In addition to the first composite conductor, the power-generating component comprises the second composite conductor which comprises the third conductor U3 and the fourth conductor U4. The latter run in opposite directions to the second composite conductor: while the slot jump of the first composite conductor takes place on the first side of the lamination stack 1, the slot jump of the second composite conductor lies on the opposite, second side. The layers L1, . . . , L10 are also always oppositely running. In order to maintain the guide symmetry beyond the third revolution, the third revolution of the second composite conductor is formed as follows: a slot jump is first carried out over six slots N1, . . . , N36 and then over seven slots N1, . . . , N36. There follows a third slot jump change in which the third conductor U3 spans six slots N1, . . . , N36, while the fourth conductor U4 merely spans four slots. Subsequently, two slot jumps are again carried out in which seven and six slots N1, . . . , N36, respectively, are spanned. The subsequent revolutions correspond to those of the first composite conductor and are merely in the opposite direction. Accordingly, in this embodiment example, the power-generating component which is wound to completion with the two composite conductors has two slot jump changes in every revolution which are located at the same slots N1, . . . , N36 or at least adjacent slots N1, . . . , N36. Accordingly, all of the slot jump changes are arranged at the lamination stack 1 radially adjacent to one another. This can also include the phases that have not been entered.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or 5 described or suggested form or embodiment as a general matter of design choice. It is the intention, therefore, to be limited only as indicated by the scope of the claims appended hereto.

1.-9. (canceled)

10. A power-generating component of an electric machine, comprising:
an annular lamination stack with a plurality of radially arranged slots; and
a wave winding with at least a first continuous conductor and a second continuous conductor which are each guided in a plurality of revolutions through adjacent slots and which are connected in parallel or in series and form a composite conductor,
wherein the composite conductor has a slot jump in which the first continuous conductor and the second continuous conductor, respectively, span an equal number of slots and in which there is a layer change, and the composite conductor has at least one slot jump change in which the first continuous conductor and the second continuous conductor span different numbers of slots such that an arrangement of the first continuous conductor and the second continuous conductor relative to one another is swapped after the slot jump change,
wherein there is at least one slot jump change within every revolution of the composite conductor.

11. The power-generating component according to claim 10, wherein the first continuous conductor and the second continuous conductor, respectively, comprise a curved winding head having an S-shaped twist at its apex.

12. The power-generating component according to claim 11, wherein the curved winding heads of the first continuous conductor and second continuous conductor are arranged parallel to one another in a slot jump.

13. The power-generating component according to claim 10, wherein the slot jump changes are arranged radially adjacent to one another at the lamination stack.

14. The power-generating component according to claim 10,
wherein, in a first slot jump change, the first continuous conductor spans one slot more compared with the slot jump and the second continuous conductor spans one slot less compared with the slot jump and, in a second slot jump change, the first continuous conductor spans one slot less compared with the slot jump and the second continuous conductor spans one slot more compared with the slot jump,
wherein the second slot jump change takes place exactly one revolution before or after the first slot jump change.

15. The power-generating component according to claim 14, wherein, in a third slot jump change, the first continuous conductor spans two slots more compared with the slot jump and the continuous second conductor spans a same number of slots compared with the slot jump, or the first continuous conductor spans the same number of slots compared with the slot jump and the second continuous conductor spans two slots less compared with the slot jump.

16. The power-generating component according to claim 15, wherein the third slot jump change takes place one revolution after the first and/or second slot jump change.

17. The power-generating component according to claim 10, wherein the wave winding has a plurality of phases comprising one or more composite conductors in each instance.

18. A wave winding for insertion in a power-generating component of an electric machine, comprising:
an annular lamination stack with a plurality of radially arranged slots; and
a wave winding with at least a first continuous conductor and a second continuous conductor which are each guided in a plurality of revolutions through adjacent slots and which are connected in parallel or in series and form a composite conductor,
wherein the composite conductor has a slot jump in which the first continuous conductor and the second continuous conductor, respectively, span an equal number of slots and in which there is a layer change, and the composite conductor has at least one slot jump change in which the first continuous conductor and the second continuous conductor span different numbers of slots such that the arrangement of the first continuous conductor and the second continuous conductor relative to one another is swapped after the slot jump change, wherein there is at least one slot jump change within every revolution of the composite conductor.
